(19) United States
(12) Patent Application Publication
(10) Pub. No.: US 2006/0124016 A1
(43) Pub. Date: Jun. 15, 2006

(54) Security element for documents

(76) Inventor: Johannes Georg Schaede, Wurzburg (DE)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 10/540,810

(22) PCT Filed: Jan. 8, 2004
(86) PCT No.: PCT/IB04/00059

§ 371 Date: Jan. 6, 2006

(30) Foreign Application Priority Data
Jan. 15, 2003 (EP) 03000613.4

(51) Int. Cl. G03G 15/32

(52) U.S. Cl. 101/494

(57) ABSTRACT

The Security element for objects (1) such as securities, banknotes, checks, passports and other similar documents comprises a structure (2a, 2b, 2c, 2d) on at least a first surface of said object, said structure being characteristically recognisable by feel along a specific direction over the structure.

The present invention concerns a security element for documents, such as securities, banknotes, checks, passports and other similar documents.

In the field of banknotes, securities and other similar documents, there has been increasing needs for security features protecting against counterfeiting. Indeed, in the past years, computers, scanners and copy machines have been extensively developed and today, it is possible to buy very performing devices at a reasonable price. Since these devices are more performing, it has been at the same time necessary to develop new and improved security features for securities, banknotes, checks, cards (i.e. credit cards), ID cards, passports etc. which would not allow them to be copied by standard computers or scanners, or even modern colour copy machines.

Such security features include, for example, special inks with iridescent properties, so called optically variable inks, used to print specific patterns on the substrate of the note, optically variable devices (such as holograms, kinegrams) in the shape of metallised patches, or also specific patterns, such as moire patterns and other similar patterns, all of which are very difficult if not impossible to copy by actual machines, but, on the other hand, are easy to control visually.

Other security features include combinations of superimposed lines and/or patterns with colours, which are only visible under specific conditions, for example UV light or by transparency. Again, the interest of such security means is that they may easily be printed or placed on the document to be protected and also be controlled by simple devices, even visually, but they are impossible to reproduce with actual printers, scanners or copy machines.

Another specific technique involves watermarks in which the paper substrate is marked with lines or patterns only visible in transparency. A further development of this technique concerns pseudo-watermarks consisting in the creation of a window in the substrate, especially in paper-based substrates, which are normally not transparent, said window being transparent.

All these elements are performant per se or in combination and it has also been necessary to create security elements created by different techniques which are then combined together on the same substrate to further increase the difficulty of counterfeiting said security.

Usually, since securities and other similar documents are printed matter, it has been interesting to develop specific security element using printing techniques. As mentioned above, one can use special inks (i.e. iridescent inks or optically variable inks), or combinations of different printing techniques for different parts of the securities such that they are impossible to reproduce with standard printing or scanning devices.

In addition, the protections of securities by using intaglio printing techniques has a long tradition. The printing process necessary to produce such securities is however complicated and the machine and materials are special. For example, U.S. Pat. No. 5,062,359, U.S. Pat. No. 4,516,496 and U.S. Pat. No. 5,899,145, the contents of which are enclosed by reference in the present application, all disclose intaglio printing machines.

Further, the recognition in the public of intaglio security elements is surprisingly good. Many factors contribute to this fact: the printability of extremely fine structures such as micropoints, of sharp edges and lines, the use of deep gravures in the intaglio plates which create a considerable embossing of the substrate (i.e. paper) and the relief structure of ink on the paper. With a certain depth of the engravings (25 μm to 120 μm), easily palpable structures are created. Such structures are further widely recognizable in the public.

U.S. Pat. No. 5,871,615, the content of which is incorporated by reference in the present application, discloses an example of a security paper with a wet embossing texturing and marking technology providing a tactile pattern. The security paper carries an intricate tactile surface profile pattern which has been imparted to the paper during its manufacture, at a stage after initial de-watering but before final drying, by passing the paper through a nip between a forming surface corresponding to the desired pattern and a backing surface.

It is therefore an aim of the present invention to improve the known security elements.

Another aim of the present invention is to provide a security element that is at the same time easy to create and difficult or impossible to reproduce with simple means accessible to the public.

A further aim of the invention is to create a structure, for example an intaglio structure, preferably on both sides of a substrate that is specifically palpable by simple moving of a finger along the structure. The palpable characteristic is then distinctly different from the palpability of other structures.

These aims are attained by the security element as defined by the claims.

An idea behind the present invention is to obtain a tactile security element, which is characteristically recognizable by moving a fingertip along a direction of the structure forming the element, thus forming a directional palpability.

For example, the structure may be created by a succession of lines on the securities.

The directional palpability may be created by a structure formed by the lines, i.e. lines orientated in different directions or by a structure in the lines themselves, or even by a combination of both.

Such a security element can be applied to security document such as banknotes, passports, checks and all other similar objects.

The invention will be better understood by the description of several embodiments with the accompanying drawings in which:

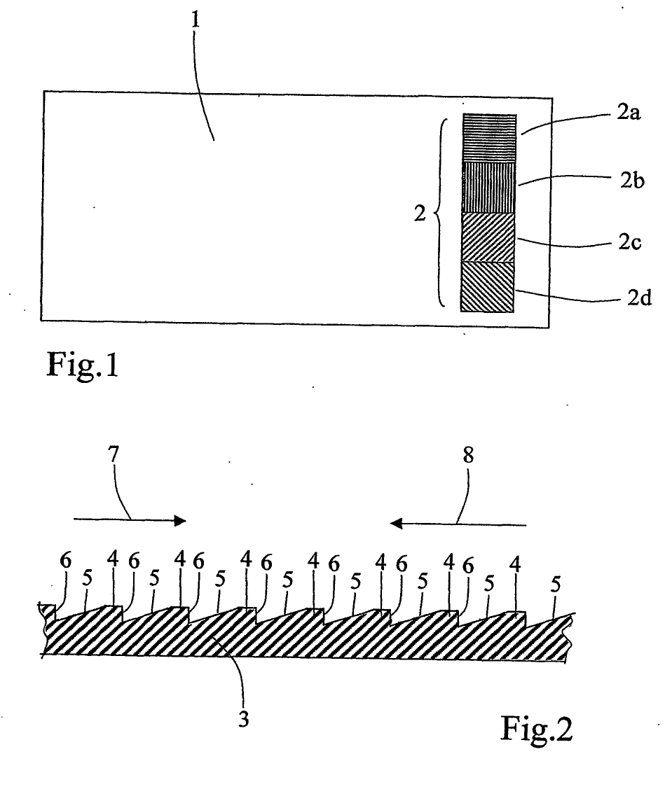

FIG. 1 shows a first embodiment of the security element of the present invention.

FIG. 2 shows a transverse cut of a security element according to a second embodiment of the present invention.

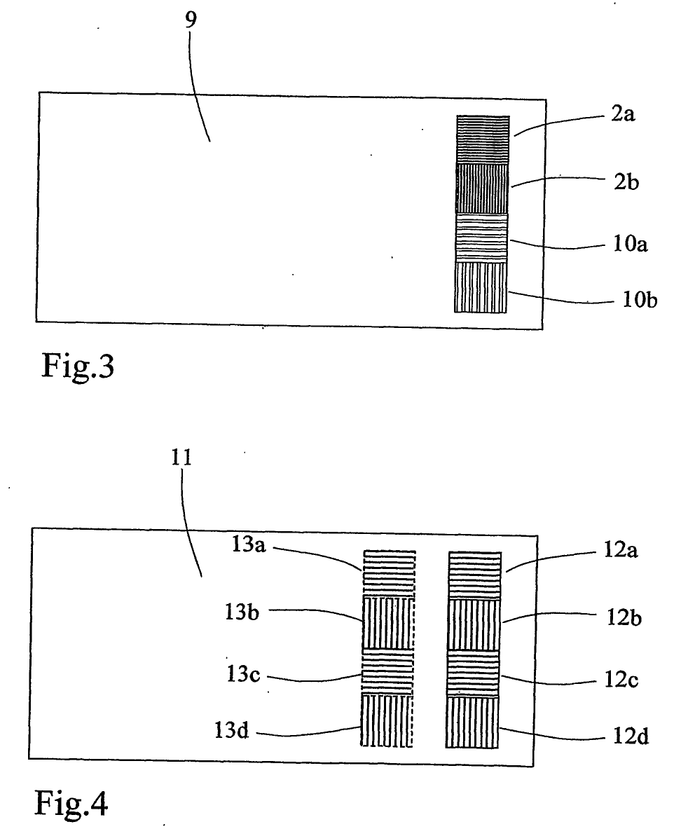

FIG. 3 shows a security document with security elements according to a combination of first and second embodiments of the present invention.

FIG. 4 shows security elements according to the invention placed on both side of a document, in a first configuration.

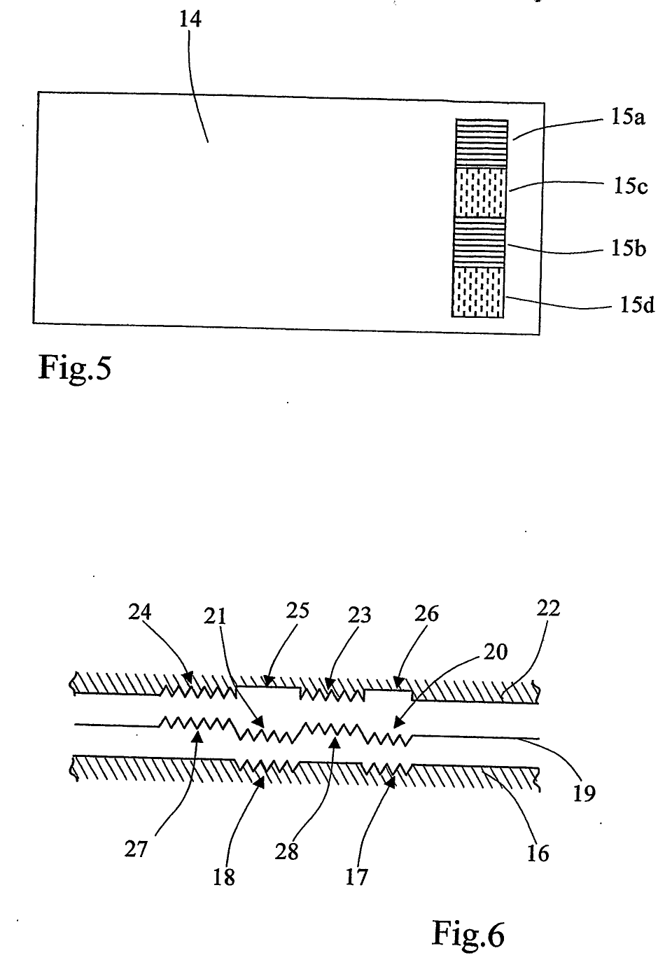

FIG. 5 shows security elements according to the invention placed on both side of a document, in a second configuration.

FIG. 6 shows schematically plates suitable for producing the security element according the invention.

In FIG. 1, a security document 1, such as a bank note, has received a security element 2 according to the invention. The security element 2 comprises several zones 2a to 2d, each zones comprising a set of parallel lines. The lines of neighbouring zones 2a to 2d are further oriented differently, in the case of FIG. 1 perpendicularly in zones 2a and 2b, in order to provide tactile changes when the tip of a finger passes over the security element. Since the tip of a finger is very sensitive, the change of direction of the lines can be immediately felt. It is of course also possible to place the lines with other orientations than perpendicular, for example to vary the angular orientation of the lines of one zone with respect to the lines of a neighbouring zone as shown in zones 2c and 2d. It is also possible to combine different orientations, i.e. longitudinal, transversal and diagonal as is shown in zones 2a to 2d of FIG. 1.

FIG. 2 shows a second embodiment of the security element according to the invention. In this embodiment, the structure itself is asymmetrical in order to provide a tactile differentiation. Accordingly, the substrate 3 forming the security note comprises asymmetrical notches 4 with a slope 5 on one side and a vertical border 6 on the other side thus rendering a different tactile feeling when the tip of a finger is passed over the structure in the direction according to arrow 7 or in the direction according arrow 8.

FIG. 3 shows schematically a security document 9, such as a banknote, with a security element comprising a combination of the security elements of first and second embodiment of the present invention. Zones 2a and 2b are the same as the zones 2a and 2b described in FIG. 1, with a set of lines oriented in a first direction in zone 2a and a set of lines oriented in another direction in zone 2b, in zone 10a, the structure being of the type shown in FIG. 2, with asymmetrical notches, and zone 10b with the same asymmetrical notches than in FIG. 2, but oriented in another direction with respect to the notches of zone 10a. The example disclosed is of course not to construed as limiting and any combination of zones is possible: for example a zone 2a with a zone 10a, or 2b with 10b, or even 2a with 10b or 2b with 10a.

In FIG. 4, security elements according to the present invention are placed on both sides of a security document 11, i.e. on the recto and the verso sides. This document comprises a first set of zones 12a, 12b, 12c and 12d which may correspond respectively to zones 2a, 2b, 2c, 2d, 10a, 10b of FIGS. 1 and 3, or a combination thereof, and on the verso side, another set of zones 13a, 13b, 13c and 13d has been made. Again, this set of zones may correspond respectively to zones 2a, 2b, 2c, 2d, 10a, 10b of FIGS. 1 and 3, or a combination thereof. In order no to interfere with one another, the zones in this configuration should be placed adjacent to each other as shown and not superposed. In FIG. 5, a second configuration with security elements placed on both recto verso sides of a document 14 are shown. In this configuration, the zones forming the security elements are superposed, therefore zones 15a and 15b are one the same side of the document (for example the recto) and zones 15c and 15d are on the other side (verso) and the zones are further alternated in order not to interfere with one another. It is of course also possible to place zones 15a and 15b next to each other on one side of the document 14, and zones 15c and 15d next to each other on the other side of the document. In this case, it is better to change the orientation of the lines forming the zones 15a, 15b and 15c, 15d respectively to reproduce the embodiment shown in FIG. 1 for neighbouring zones with lines having different orientations. As with the embodiment disclosed in FIG. 4, the zones 15a to 15d may be made of lines with different orientations (longitudinal, transversal or oblique) and/or with asymmetrical notches as disclosed in FIG. 2, or a combination of lines and/or notches.

It is also possible to have lines in the zone 15a (recto) and 15c (verso) with identical directions, the palpable effect being presence of lines on the recto side (zone 15a) with at the same time absence of lines on the verso side, then presence of lines on the verso side (zone 15c) with absence of lines on the recto side, and then again presence of lines on the recto side (zone 15b) with absence of lines on the verso side, then presence of lines on the verso side (zone 15d) with absence of lines on the recto side. This alternate effect can be easily felt by passing a security document with this element between the thumb and the index finger.

In FIG. 6, an example of intaglio plates suitable to print a security element according to the invention is shown in a schematical way with exaggerated engravings for the sake of clarity. To facilitate the understanding, the plates are represented next to each other, but it is clear that the verso intaglio printing and the recto intaglio printing are carried out one after the other with two different intaglio plate cylinders.

Accordingly, the verso plate 16 comprises, as an example, two zones 17, 18 with engravings which are used as is common in an intaglio printing process to mark a substrate 19 intaglio structures 20 and 21. Once the verso side is finished, the substrate 19 is then brought against the recto plate 22 which also comprises zones with engravings 23 and 24. However, in order not to destroy the intaglio structures 20 and 21 of the substrate 19 on the verso side when the recto side is being processed, recto plate 22 comprises recesses 25 and 26 which are in register, with respect to the substrate 19, with the intaglio structures 20 and 21 of the verso side.

The substrate 19 then receives the recta intaglio structures 27 and 28 as shown in FIG. 6. This configuration is particularly suitable for the example of security element disclosed in FIG. 5, in which there are alternate security elements (15a to 15d) on both sides of the substrate 14.

The structures placed in the zone can be produced by an intaglio printing process as is known in the art of printing, in which the substrate (for example paper) is pressed and deformed in engravings of printing plates. U.S. Pat. Nos. 5,062,359 and 4,516,496, enclosed by reference in the present application, disclose examples of such intaglio printing techniques.

The structure effect may also be partially or totally carried out by the ink deposited on the substrate, by creating reliefs through the patterns formed by the ink itself. In this case, other than intaglio printing techniques could be used to obtain the same tactile effect.

The number of four different zones is used as non-restricting examples in the different embodiments disclosed. In it obvious than only one zone may be used when one uses the configuration of FIG. 2. For the other configurations, it is preferred to use at least two zone with lines orientated differently as can be understood from the principle of the invention.

In addition, asymmetrical notches have been shown as examples but other asymmetrical shapes having the same effect can be used as equivalent means.

The structures of the invention are also not limited to lines, given as non-limiting examples but other equivalent configurations are possible, for example dots, waves, and other similar structures can be used alone or in combination.

1-12. (canceled)

13. A security element for objects such as securities, banknotes, checks, passports and other similar documents,
wherein said security element comprises a tactile structure on at least a first surface of said object, said tactile structure comprising a succession of lines and being characteristically recognizable by feel along a specific direction over the tactile structure.

14. The security element as claimed in claim 13, wherein the lines have an asymmetrical relief profile.

15. The security element as claimed in claim 13, wherein the lines have different orientations.

16. The security element as claimed in claim 13, wherein said tactile structure comprises at least two neighboring tactile zones each having a distinct directional palpability.

17. The security element as claimed in claim 13, wherein said tactile structure is made by deformation of the object.

18. The security element as claimed in claim 13, wherein said tactile structure is made by an intaglio process.

19. A security element for objects such as securities, banknotes, checks, passports and other similar documents,
wherein said security element comprises a tactile structure on at least a first surface of said object, said tactile structure comprising a succession of shapes having an asymmetrical relief profile and being characteristically recognizable by feel along a specific direction over the tactile structure.

20. The security element as claimed in claim 19, wherein said tactile structure comprises at least two neighboring tactile zones each having a distinct directional palpability.

21. The security element as claimed in claim 19, wherein said tactile structure is made by deformation of the object.

22. The security element as claimed in claim 19, wherein said tactile structure is made by an intaglio process.

23. A security element for objects such as securities, banknotes, checks, passports and other similar documents,
wherein said security element comprises a tactile structure which is characteristically recognizable by feel along a specific direction over the tactile structure, said tactile structure comprising first and second tactile zones placed next to each other respectively on a recto side and a verso side of the object.

24. The security element as claimed in claim 23, wherein said tactile structure comprises a succession of tactile zones which are alternately disposed on the recto and verso side of the object.

25. The security element as claimed in claim 23, wherein said tactile structure is made by deformation of the object.

26. The security element as claimed in claim 23, wherein said tactile structure is made by an intaglio process.

27. A combined security element comprising at least a security element according to claim 13 and a security element according to claim 19.

28. A document, such as a banknote, a check or a passport, comprising at least one security element as claimed in claim 13.

29. A document, such as a banknote, a check or a passport, comprising at least one security element as claimed in claim 19.

30. A document, such as a banknote, a check or a passport, comprising at least one security element as claimed in claim 23.
